(19) United States
(12) Patent Application Publication
(10) Pub. No.: US 2011/0001698 A1
(43) Pub. Date: Jan. 6, 2011

(54) Visualization Device Comprising at Least One Prohibited Zone and a Pointer

(75) Inventors: Nicolas Dides, Merignac (FR); Denis Bonnet, Bordeaux (FR); Xavier Servantie, Pessac (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/602,990

(22) PCT Filed: Jun. 4, 2008
(86) PCT No.: PCT/EP2008/056908

§ 371 Date: Jun. 30, 2010

(30) Foreign Application Priority Data
Jun. 5, 2007 (FR) 0704014

(51) Int. Cl. G06F 3/033

(52) U.S. Cl. 345/157

(57) ABSTRACT

The visualization device comprising computation means, display means including at least one prohibited zone and a system for guiding a pointer is characterized in that the pointer can remain immobile in the prohibited zone only for a limited duration, the pointer being automatically directed toward the outside of the prohibited zone after this limited duration.

### PRIORITY CLAIM

This application claims priority to PCT Application Number PCT/EP2008/056908, entitled Visualization Device Comprising at Least One Prohibited Zone and a Pointer, filed on Jun. 4, 2008 and French Application Number 07 04014 entitled Visualization Device Comprising at Least One Prohibited Zone and a Pointer filed Jun. 5, 2007.

### TECHNICAL FIELD

The present invention relates to a visualization device, notably a pointer, animated by guidance means of the “mouse” type on critical zones of a visualization screen. The invention lies in the field of electronic and computer application display systems and more particularly it is applied to the display systems comprising visualization screens of a cockpit presenting information that is critical to the safety of an aircraft flight, for example helicopter visualization screens.

### BACKGROUND OF THE INVENTION

Currently, in the electronic systems comprising general consumer type visualization screens such as computers, a pointer is generally used in most applications. In this case, systems for guiding the pointer are generally mice. The pointer guided by a mouse is not subject to critical display conditions in this type of general consumer application. Moreover, the information generally presented on the screen can be partially masked by a pointer without causing any inconvenience to the user. A priori, no ambiguity in interpreting a displayed symbol system is critical. Furthermore, a user can act on the movement of the pointer and on its position so as to always obtain a non-incorrect interpretation of the symbol system displayed and thus eliminate any reading ambiguity.

In aeronautics, in the aircraft and more particularly in helicopters, the display screens are often small through the need for integration and the information displayed can be critical, the latter making it possible to handle the flight of the aircraft. Among this information, the current altitude and navigation and guidance information are presented on the screen. An accurate and unambiguous interpretation of the information displayed on a visualization screen is necessary. Moreover, in the various electronic systems that have a visualization screen, a pointer generally makes it possible to interact with interactive symbol systems in various zones of the screen. The means of guiding the pointer may be a moving ball, also called “trackball” to use the correct terminology, incorporated in the cockpit or in dedicated equipment in the various electronic systems of the cockpit.

Among the information presented in the various zones of a visualization screen, some zones are not dedicated to interacting with the crew; these zones are generally used to display data that can assist the crew in handling the flight in nominal conditions. It is necessary for the pointer not to mask this information, given the critical need to consult the information displayed in certain conditions. In these conditions, the danger can stem from a comma, a numeral or an alarm, for example that may be masked by the pointer.

These days, it is possible to completely disable certain zones, for example by prohibiting access to a pointer in a certain zone of the screen corresponding to a portion intended to display critical data. Nevertheless, depending on the applications of the onboard electronic systems, it is not always possible to prohibit a zone of the screen if the latter is included between two accessible interactive zones.

FIG. 1A represents a visualization screen 1 comprising four separate zones (2, 3, 4, 5), each being dedicated to display symbol systems to the crew of various kinds. In the example, the zone 4 is a prohibited zone in which the pointer must not mask the critical information in order not to induce a reading interpretation error. If the crew wants to move the pointer from the position 7 to the position 6 to confirm an action, the only possible solution is to guide the pointer so as to circumvent the zone 4 by passing through the zone 5 and returning to the interior of the zone 3.

In the same way, another possible exemplary case is represented in FIG. 1B in a visualization screen 1. Three zones (8, 9, 10) are defined, including a prohibited zone 10 and two interactive zones 8 and 9. At the present time, there is no simple solution for moving the pointer from the zone 9 to the zone 8, that is to say from the position 7 to the position 6′. However, it is possible to move the pointer from an interactive zone to another interactive zone in a discontinuous movement by a “hop” from the zone 10 by passing directly from the zone 9 to the zone 8. This solution has the drawback of not being ergonomic for the crew who may be hampered by the visual loss of the pointer for a fraction of a second, and therefore a break in the continuity of its mental representation of the situation.

The drawback of such a system is having to define, from the application design stage, critical zones on the edges of a screen without taking into account the adequacy of the coherence of the content of the information and the ease of reading for the crew.

Furthermore, the displacement of the pointer must retain a certain continuity in its movement and ensure a faithful execution of the will of the crew by the pointer guidance means. Moreover, the movements of the pointer must be natural and simple, which is not the case in FIG. 1A in which a circumvention of a prohibited zone is necessary.

### SUMMARY OF THE INVENTION

One aim of the invention is notably to overcome the abovementioned drawbacks. To this end, the object of the invention is to modify the behavior of the pointer notably in terms of speed and guidance when the latter is situated on a prohibited zone, that is to say, a zone containing information that must not be masked by the pointer.

If the pointer is abandoned on a prohibited zone, the invention makes it possible to prevent the pointer from stopping there by pushing it back to the edges of the prohibited zone. Moreover, the invention makes it possible to displace the pointer on passing from a prohibited zone if the latter is crossed without interruption.

Advantageously, the visualization device comprising computation means, display means including at least one prohibited zone and an authorized zone and a system for guiding a pointer is characterized in that the pointer can remain immobile in the prohibited zone only for a limited duration, the pointer being automatically directed toward the outside of the prohibited zone by the guidance system after this limited duration.

Advantageously, the displacement of the pointer to leave the prohibited zone is minimal.

Advantageously, the prohibited zone is divided into a number of portions, each comprising at least one side forming a boundary of the prohibited zone with an authorized zone, each portion defining the direction and the speed of displacement of the pointer.

Advantageously, a speed vector applied to the pointer in a portion is perpendicular to a side of the portion forming a boundary with a neighboring zone.

Advantageously, the intensity of the speed of the speed vector applied to the pointer decreases in the vicinity of a boundary of the prohibited zone and is almost constant when it is displaced above the prohibited zone.

Advantageously, the graphic representation, such as the color, the shape and/or the transparency of the pointer, vary when it is situated on a prohibited zone.

Advantageously, the limited duration is between 0 ms and 300 ms.

Advantageously, the maximum duration to reach the edge of a prohibited zone is 500 ms when the pointer is abandoned on the latter zone.

### BRIEF DESCRIPTION OF THE DRAWINGS

Other characteristics and advantages of the invention will become apparent from the following description, given in light of the appended drawings which represent:

FIGS. 1A & 1B: two representations of visualization comprising a number of zones according to the prior art;

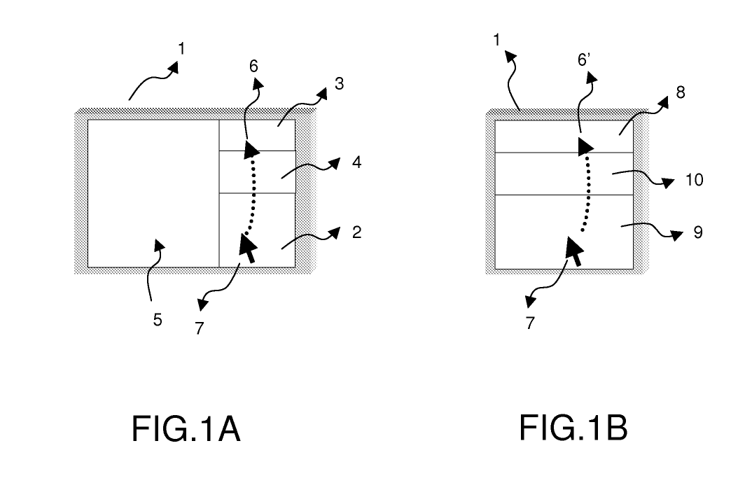

FIGS. 2A & 2B: a first exemplary prohibited zone modifying the properties of the pointer;

FIG. 3: an exemplary modification of the transparency of the pointer in its passage over a prohibited zone;

FIG. 4: an exemplary change in the speed of the pointer when the latter crosses a prohibited zone;

FIGS. 5A & 5B: a second exemplary prohibited zone modifying the properties of the pointer;

FIGS. 6A & 6B: a third exemplary prohibited zone modifying the properties of the pointer;

FIGS. 7A & 7B: a fourth exemplary prohibited zone modifying the properties of the pointer.

### DETAILED DESCRIPTION OF THE INVENTION

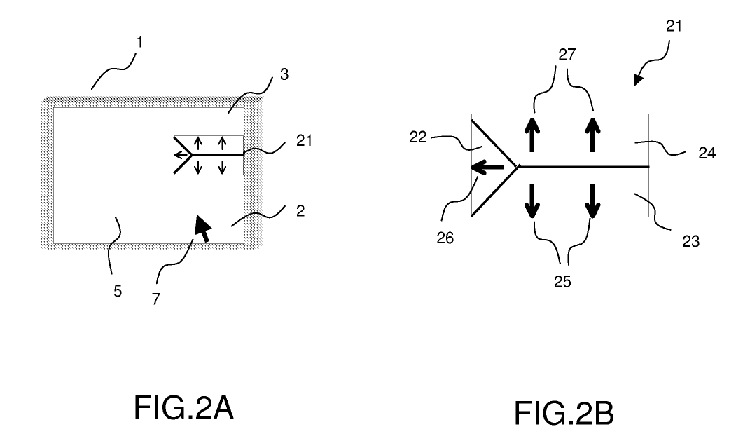

FIG. 2A illustrates a visualization screen 1 comprising four zones (2, 3, 5, 21), including a prohibited zone 21 on which the information displayed must not be masked by the pointer 7. The device according to the invention proposes defining a zone 21 comprising three separate portions 22, 23 and 24 represented in FIG. 2B.

The principle of defining the portions of a zone is to define as many portions that are necessary in the prohibited zone as the prohibited zone comprises sides forming a boundary with other zones. In this way, each portion (22, 23, 24) has a single side in common with a neighboring zone (2, 3, 5).

When the pointer is passed over the zone 21, if the pointer is moving and no interruption in the movement of the pointer is detected by the device, the crossing into the zone is performed as in all the other zones of the screen.

When inactivity of the pointer is detected when it is situated on the prohibited zone, each of the portions forming the prohibited zone 21 makes it possible to define a single direction for pushing back the pointer by a speed of displacement applied to the pointer.

When the pointer is abandoned over the zone 21, depending on whether it is situated on one of the portions 22, 23 or 24, a speed vector 26, 27 or 25 is applied to the pointer directing it toward the outside of the zone 21.

The speed vectors are defined for each of the portions that make up the prohibited zone 21, so that they are perpendicular to the boundary between the prohibited zone 21 and a neighboring zone 2, 5 or 3.

The speed vectors applied to the pointer 7 are active over the entire area of each portion.

Thus, according to the example of FIGS. 2A and 2B, if the pointer is abandoned on the portion 23, it is pushed back into the zone 2. If the pointer is abandoned on the portion 24, it is pushed back into the zone 3. If the pointer is abandoned on the portion 22, it is pushed back into the zone 5.

In a variant embodiment, it can be considered that the speed vectors form a determined angle with the perpendicular of each boundary of each portion. This angle can advantageously be that made by the trajectory of the pointer with the boundary before its abandonment.

The pointer is considered to be abandoned if it remains without moving for a duration that is short enough not to be a problem for the crew. An acceptable duration is between 0 ms and 300 ms. 150 ms is one example of a case of embodiment according to the invention.

In as much as the prohibited zone is crossed only in order to go beyond it to pass to the other side, this time constraint is absolutely not a nuisance to the operator because the movement of the pointer is continuous.

From the moment when this detection takes place, the inventive device makes it possible to drag the pointer to the edge of a portion of the prohibited zone that is closest. The speed of displacement of the pointer is fast enough for a symbol system of the zone not to be masked for too long and it is also limited so that the user can perceive the movement of the pointer. A maximum duration of 500 ms to get back to an authorized zone regardless of the position of the pointer in the prohibited zone is one example.

The inventive device proposes applying a speed to the pointer so that it is displaced continuously for the operator to be able to follow it by eye. In this case, the operator visually retains the information concerning the position of his pointer, so the continuity of his mental representation is assured.

If the user resumes guiding the movement of the pointer, he must resume it from the current position of the pointer, even during an automatic movement on a prohibited zone.

The trajectory of the pointer is linear, but its speed can be adapted to give the impression that the pointer is sliding on a slope as if it were crossing a “virtual hill”.

One possible embodiment case consists in modifying the color, the shape and/or the transparency of the pointer or when crossing the prohibited zone 21. A coloring makes it possible, for example, to indicate to the crew or to the operator that the pointer is situated on a prohibited zone.

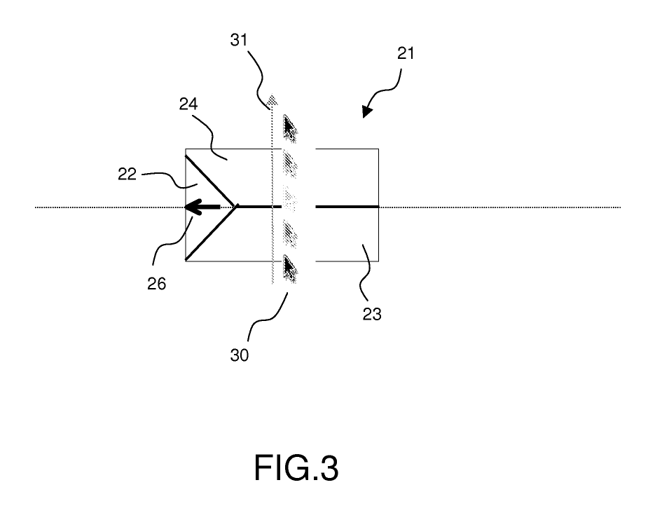

In an embodiment case represented in FIG. 3, when the passage from the prohibited zone 21 is performed continuously by the pointer, the device proposes modifying the opaqueness and/or the transparency of the pointer 30. The transparency of the pointer is variable along the axis 31 perpendicular to one of the boundaries of the prohibited zone 21. The device then modifies the appearance of the pointer progressively: in the vicinity of the edges of the prohibited zone 21, the transparency of the pointer is unmodified and in the vicinity of the center of the prohibited zone 21 the pointer is made almost transparent. One example is to render the pointer semi-transparent at mid-travel when it is crossing the prohibited zone 21 in order not to mask important information even in a continuous movement in the zone.

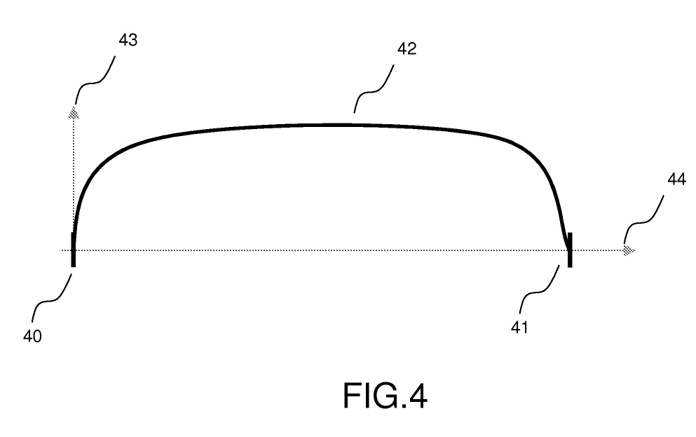

FIG. 4 represents an exemplary modification of the speed gradient of the pointer when the latter crosses the prohibited zone.

The speed applied to the pointer on entering 40 of the prohibited zone is low, identified on the axis 43, and increases progressively to reach a nominal speed 42. Then, when the pointer is approaching the boundary 41 of the prohibited zone to leave it again, the speed of the pointer decreases, the axis 44 representing the displacement of the pointer.

In a variant embodiment, the inventive device proposes retaining the speed law defined previously over the prohibited zone even an operator is guiding the pointer.

In the latter case, when the pointer begins to cross a prohibited zone by an action guided by an operator, its speed is accelerated by a little which makes it possible to ensure a certain continuity of movement and convenience for the user. Then, the extra speed applied to the pointer when crossing the prohibited zone on each portion is almost constant to finally decrease in the vicinity of an edge of the prohibited zone.

This solution has the advantage of accompanying the movement initiated by an operator and of guiding the pointer to the other side of the prohibited zone.

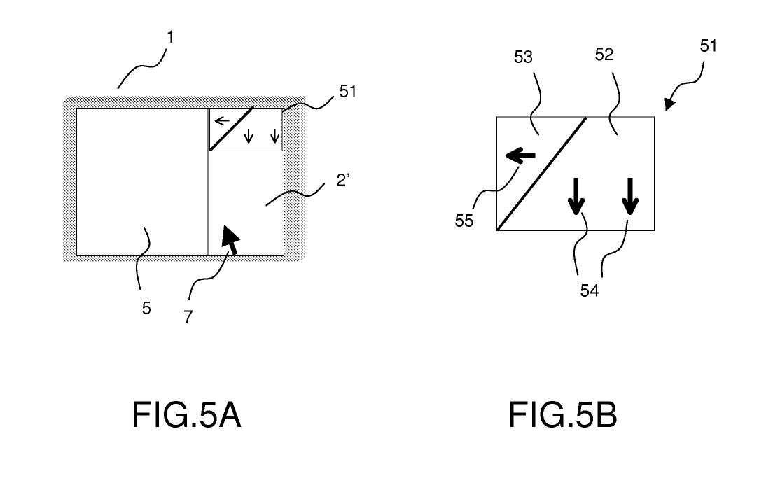

FIGS. 5A and 5B represent a second exemplary case of the arrangement of a prohibited zone 51 in a visualization screen 1 comprising two other zones 2′ and 5. The prohibited zone 51 comprises two separate portions 52 and 53.

Each of the portions 52 and 53 respectively comprises speed vectors 54 and 55 that are applied to the pointer 7 over their entire area. In this example, the pointer 7 can access the zones 2′ and 5. When the pointer is situated over the zone 51 and an inactivity of the latter is detected, then the pointer is pushed back to the outside of the prohibited zone, either into the zone 5 if the latter is abandoned in the portion 53, or into the zone 2′ if the latter is abandoned in the portion 52.

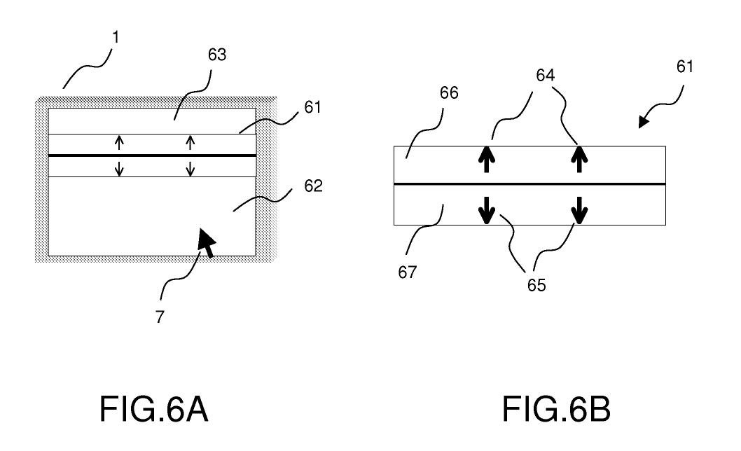

FIGS. 6A and 6B represent a third exemplary case of the arrangement of a prohibited zone 61 in a visualization screen 1 comprising two other zones 62 and 63. The prohibited zone 61 comprises two separate portions 66 and 67.

Each of the portions 66 and 67 respectively comprises speed vectors 64 and 65 that are applied to the pointer 7 over their entire area. In this example, when the pointer is situated over the zone 61 and an inactivity of the latter is detected, then the pointer is pushed back either into the zone 63 if the latter is abandoned in the portion 64 or into the zone 65 if the latter is abandoned in the portion 67.

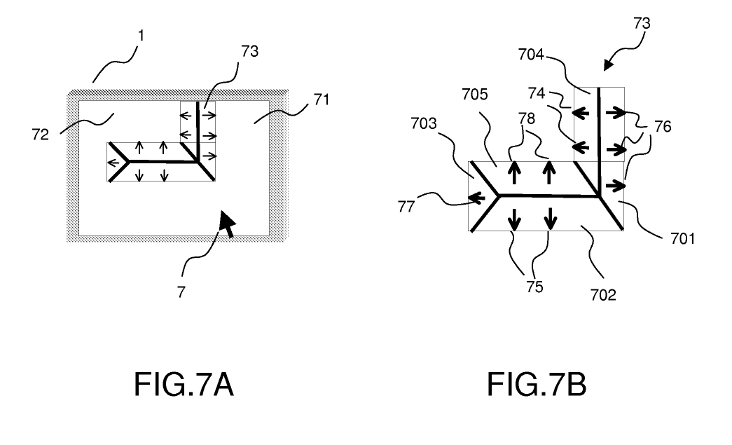

A fourth exemplary case is represented in FIGS. 7A and 7B in a visualization screen 1.

A prohibited zone 73 forms an “L” partially separating two zones 71 and 72 in which the presence of the mouse does not affect the reading of the information presented on the screen. The critical zone is defined by the prohibited zone 73 on which the pointer must not hamper the reading of the information presented in this portion of the screen.

The prohibited zone 73 is formed by five separate portions (701, 702, 703, 704, 705). There are as many different portions defined as the prohibited area has boundaries with neighboring zones.

Each of the portions applies a vector pushing back the pointer to its boundary with a neighboring zone. Each vector is perpendicular to the boundary.

Thus, if the pointer is abandoned over the prohibited zone 73, depending on the portion over which the pointer is situated, the portion 701 pushes back the pointer according to the vector 76, the portion 702 pushes back the pointer according to the vector 75, the portion 703 pushes back the pointer according to the vector 77, the portion 704 pushes back the pointer according to the vector 74, the portion 705 pushes back the pointer according to the vector 78, toward the outside of the prohibited zone 73.

In an embodiment case, the inventive device is also applied to windows of applications of one and the same visualization screen that can each define a zone as defined previously. In this case in point, some windows are defined as prohibited zones and other windows can be defined as zones comprising symbol systems that interact with the pointer. One advantage is to be able to displace the windows and retain the properties of the prohibited zones, notably the defined speed vectors.

In a variant embodiment comprising two or more visualization screens, the inventive device can be applied to zones contained on a number of screens, the pointer being able to pass from one screen to another.

The main advantage of the invention is to make it possible to define as many prohibited zones as are desired according to the application. The shapes of the prohibited zones can easily be adapted to the geometry of the windows of an application and the content presented.

Application developments are advantageously decorrelated from the presentation and the display ergonomy and the consistency of presentation of the information and of the symbol systems can be retained.

What is claimed is:

1. A visualization device comprising computation means, display means including at least one prohibited zone and an authorized zone and a system for guiding a pointer, wherein the prohibited zone is divided into a number of portions, each of the portions comprising al least one side forming a boundary of the prohibited zone with an authorized zone, each portion defining the direction and the speed of displacement of the pointer, the pointer remaining immobile in the prohibited zone only for a limited duration, the pointer being automatically directed according to a minimal displacement toward the outside of the prohibited zone by the guidance system after this limited duration.

2. The visualization device as claimed in claim 1, wherein the prohibited zone is divided into a number of portions, each of the portions comprising at least one side forming a boundary of the prohibited zone with an authorized zone, each portion defining the direction and the speed of displacement of the pointer.

3. The visualization device as claimed in claim 2, wherein a speed vector applied to the pointer in a portion is perpendicular to a side of the portion forming a boundary with the authorized zone.

4. The visualization device as claimed in claim 3, wherein the intensity of the speed of the speed vector applied to the pointer decreases in the vicinity of a boundary of the prohibited zone.

5. The visualization device as claimed in claim 3, wherein the intensity of the speed of the speed vector applied to the pointer is almost constant when it is displaced above the prohibited zone.

6. The visualization device as claimed in claim 3, wherein the shape and/or the color and/or the transparency of the pointer vary when it is situated on a prohibited zone.

7. The visualization device as claimed in claim 3, wherein the limited duration is between 0 ms and 300 ms.

8. The visualization device as claimed in claim 3, wherein the maximum duration to reach the edge of a prohibited zone is 500 ms when the pointer is abandoned on the latter zone.
